(19) United States
(12) Patent Application Publication
(10) Pub. No.: US 2024/0203177 A1
(43) Pub. Date: Jun. 20, 2024

(54) METHOD AND APPARATUS FOR INFORMING OF POWER OF VEHICLE

(71) Applicants: Kia Corporation, Seoul (KR); Hyundai Motor Company, Seoul (KR)

(72) Inventors: Hoe Young Jeong, Gwangmyeong-si (KR); Jung Seok Suh, Yongin-si (KR)

(21) Appl. No.: 18/337,306

(22) Filed: Jun. 19, 2023

(30) Foreign Application Priority Data
Dec. 16, 2022 (KR) 10-2022-0176603

(51) Int. Cl. G07C 5/08; B60R 16/033; G07C 5/02

(52) U.S. Cl. CPC G07C 5/0816; B60R 16/033; G07C 5/02; B60L 58/12

(57) ABSTRACT

In an embodiment a method includes determining, by a vehicle power guiding apparatus, a current state of the vehicle, identifying, by the vehicle power guiding apparatus, electric power of the vehicle currently in use based on the current state of the vehicle and informing, by the vehicle power guiding apparatus, a user of an identified electric power of the vehicle, wherein the current state of the vehicle includes at least one of a parked state, a stopped state, or a driving state, and wherein the identified electric power of the vehicle is displayed on a Graphical User Interface (GUI).

### CROSS-REFERENCE TO RELATED APPLICATIONS

This application is based on, and claims priority from, Korean Patent Application Number 10-2022-0176603, filed Dec. 16, 2022, the disclosure of which is incorporated by reference herein in its entirety.

### TECHNICAL FIELD

The present disclosure relates to a method and an apparatus for guiding or informing of the power of a vehicle. More particularly, the present disclosure relates to a method and an apparatus for informing of the remaining amount of power and Vehicle-to-load (V2L) power when the vehicle is parking, stopping, or driving.

### BACKGROUND

The statements in this section merely provide background information related to the present disclosure and do not necessarily constitute prior art.

Not only a solution to pollution problems such as automobile noise and exhaust gas but also for the effective usage of surplus power in relation to saving energy, electric vehicles are in the limelight as a new means of transportation. A vehicular feature, Vehicle-to-Load (V2L) refers to a technology that can utilize the battery installed in an electric vehicle as a power source for external loads. The power of the high-voltage large battery installed in the electric vehicle can be used for operating appliances or loads such as laptop computers, electric pots, electric cookers, electric grills, microwave ovens, or hairdryers. For example, when tent camping or car camping, V2L technology can be conveniently utilized. Accordingly, when utilizing V2L, the power of the vehicle should be informed to the user in detail.

### SUMMARY

According to at least one embodiment, the present disclosure provides a method including determining, by a vehicle power guiding apparatus, the current state of the vehicle, identifying, by the vehicle power guiding apparatus, electric power of the vehicle currently in use based on the current state of the vehicle, and informing, by the vehicle power guiding apparatus, a user of an identified electric power of the vehicle, wherein the current state of the vehicle includes at least one of a parked state, a stopped state, or a driving state, and the identified electric power of the vehicle may be displayed on a Graphical User Interface (GUI).

According to another embodiment, the present disclosure provides a vehicle power guiding apparatus including a memory, and a processor configured to determine a current state of a vehicle, identify electric power of the vehicle currently in use based on the current state of the vehicle, and inform a user of an identified electric power of the vehicle, wherein the current state of the vehicle includes at least one of a parked state, a stopped state, or a driving state, and the identified electric power of the vehicle may be displayed on a Graphical User Interface (GUI).

### BRIEF DESCRIPTION OF THE DRAWINGS

FIG. 1 is a diagram illustrating an onboard vehicle control apparatus used for implementing the Vehicle-to-Load (V2L) feature according to at least one embodiment of the present disclosure;

FIG. 2 is a diagram illustrating a GUI informing of the electric power of a vehicle during parking or stopping, according to at least one embodiment of the present disclosure;

FIG. 3 is a diagram illustrating the purposes of V2L usage according to at least one embodiment of the present disclosure;

FIG. 4 is a flowchart of the process of informing of the electric power of a vehicle and providing a guide to power charging during parking or stopping, according to at least one embodiment of the present disclosure;

FIG. 5 is a diagram illustrating a GUI informing of the electric power of a vehicle while driving, according to at least one embodiment of the present disclosure;

FIG. 6 is a flowchart of the process of informing of a vehicle's electric power and providing a guide to power charging while driving, according to at least one embodiment of the present disclosure;

FIG. 7 is a diagram illustrating a GUI informing of the electric power of the vehicle when the vehicle power is low, according to at least one embodiment of the present disclosure;

FIG. 8 is a diagram for explaining an optimal vehicle power charging method according to at least one embodiment of the present disclosure; and

FIG. 9 is a flowchart of a method of providing information on the vehicle power according to at least one embodiment of the present disclosure.

### DETAILED DESCRIPTION OF ILLUSTRATIVE EMBODIMENTS

Aspects of the present disclosure seek to provide a method and an apparatus for differentiating between (Vehicle-to-Load) V2L modes according to different use purposes of the V2L feature.

Another aspect of the present disclosure provides a method and an apparatus for recommending a power usage plan to a user according to the purpose of using the V2L and the amount of remaining power.

Yet another aspect of the present disclosure provides a method and an apparatus for providing an optimal vehicle power charging method to a user.

Hereinafter, some embodiments of the present disclosure will be described in detail with reference to the accompanying drawings. In the following description, like reference numerals designate like elements, although the elements are shown in different drawings. Further, in the following description of some embodiments, a detailed description of known functions and configurations incorporated therein will be omitted for clarity and for brevity.

Various ordinal numbers or alphanumeric codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, to not exclude thereof unless specifically stated to the contrary.

The description of the present disclosure to be presented below in conjunction with the accompanying drawings is intended to describe exemplary embodiments of the present disclosure and is not intended to represent the only embodiments in which the technical idea of the present disclosure may be practiced.

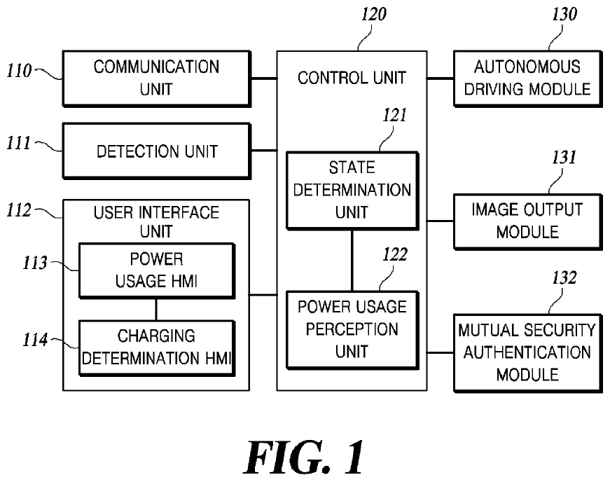

FIG. 1 is a diagram illustrating an onboard vehicle control apparatus used for implementing the V2L feature according to at least one embodiment of the present disclosure.

As shown in FIG. 1, to offer V2L capability, each vehicle may include a communication unit 110, a detection unit 111, a user interface unit 112, a control unit 120, an autonomous driving module 130, an image output module 131, and a mutual security authentication module 132. The user interface unit 112 may include a power usage Human Machine Interface (HMI) 113 and a charging determination HMI 114. The control unit 120 may include a state determination unit 121 and a power usage perception unit 122.

The communication unit 110 may transmit and receive information through a vehicle-to-vehicle communication network. The communication unit 110 may transmit and receive information between vehicles through at least one of the communication schemes including wireless LAN, wireless-fidelity (Wi-Fi), Wi-Fi Direct, Digital Living Network Alliance (DLNA), Wireless Broadband (WiBro), World Interoperability for Microwave Access (WiMAX), High Speed Downlink Packet Access (HSDPA), High Speed Uplink Packet Access (HSUPA), Long Term Evolution (LTE), and Long Term Evolution-Advanced (LTE-A) communications.

Additionally, the communication unit 110 may perform short-range communication between vehicles. Since the vehicles drive while maintaining a short distance between each other, the communication unit 110 may transmit and receive information between the vehicles through short-range wireless communication. In this case, the communication unit 110 may allow various types of information to be transmitted and received between the vehicles through Bluetooth, Radio Frequency Identification (RFID), Infrared Data Association (IrDA), Ultra WideBand (UWB), ZigBee, Near Field Communication (NFC), Wi-Fi, Wi-Fi Direct, Wireless Universal Serial Bus (Wireless USB), and the like.

The detection unit 111 may include radar, a camera, and lidar among others. The detection unit 111 may detect the speed and location of vehicles traveling nearby. The detection unit 111 may detect all objects, including obstacles, people, animals, toll booths, and breakwaters, in addition to vehicles. The user interface unit 112 may provide the driver with a user interface. The user interface unit 112 may receive information from the driver and input the same to the control unit 120 or output a result of the operation performed. For example, the driver may input information about surrounding vehicles to the user interface 112. The user interface unit 112 may input information about surrounding vehicles to the control unit 120. The control unit 120 may use the information about the surrounding vehicles to issue a control command to the autonomous driving module 130. The user interface unit 112 may be in the form of a Graphical User Interface (GUI), a HMI, or an Auditory User Interface (AUI).

The power usage HMI 113 may provide a user with an interface for the electric power in use. The power usage HMI 113 may provide the user with differentiated information items including the amount of power consumption for V2L, the amount of remaining power, and the amount of spare power. The power usage HMI 113 may recommend an optimal power usage method to the user. The charging determination HMI 114 may recommend an optimal charging method to the user when the amount of power is insufficient. The charging method may include moving to the nearest charging station, calling a specialized charging vehicle, a method of calling a V2L-capable vehicle, cutting off V2L power, and other methods.

The control unit 120 may control the autonomous driving module 130, the image output module 131, and the mutual security authentication module 132 according to information received from the communication unit 110, the detection unit 111, and the user interface unit 112. The autonomous driving module 130 may change or maintain the speed and direction of the vehicle according to the control command of the control unit 120. The image output module 131 may output images of surrounding vehicles, surrounding obstacles, surrounding buildings, etc. to the driver according to a control command of the control unit 120. The mutual security authentication module 132 may follow a control command of the control unit 120 to perform authentication using identifiers (IDs) between surrounding vehicles. Autonomous vehicles can defend against spoofing attacks by attackers through such authentication.

The state determination unit 121 may determine whether the vehicle is driving or parking/stopping. The power usage perception unit 122 may differentiate the power being used. The power usage perception unit 122 may perceive where the power of the vehicle is being used. For example, the power usage perception unit 122 may distinguish and perceive that power is being used for lamps, displays, speakers, heating and cooling, and the like.

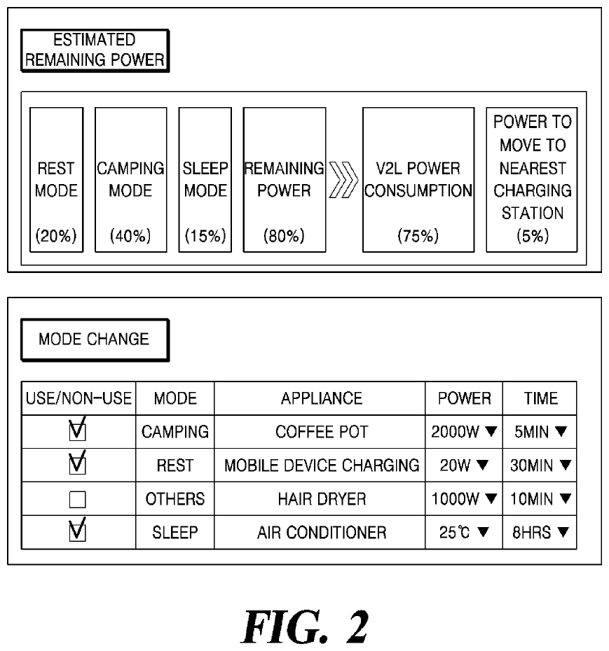

FIG. 2 is a diagram illustrating a GUI informing of the electric power of a vehicle during parking or stopping, according to at least one embodiment of the present disclosure. When the vehicle is parked or stopped, the user can enjoy a picnic or stay overnight in the vehicle. When the user uses V2L while enjoying a picnic or staying overnight in the vehicle, a V2L mode may be selected. The V2L mode may include a rest mode, a camping mode, and a sleep mode. Recommended amount of power according to the V2L mode, the amount of remaining power, and the power required to move to the nearest charging station may be displayed on the GUI.

As shown in FIG. 2, when the user stays overnight in the vehicle, the user may select the V2L mode. The V2L mode may include a camping mode, a rest mode, a sleep mode, an ‘others’ mode, and the like. The user may select between the camping mode, the rest mode, and the sleep mode. When the user has selected the camping mode, the user may use a coffee pot and consume less than 2000 W of power within 5 minutes. For example, upon selecting the camping mode, the user may use a microwave oven, gas stove, electric cooker, oven, or induction range. Upon selecting the rest mode, the user may charge a mobile device and use less than 20 W of power within 30 minutes. Upon selecting the rest mode, the user may use internal/external lamps, a beam projector, and the like. When the user selects the sleep mode, the user may use less than 1500 W of power within 8 hours with an air conditioner in the vehicle. This can maintain the temperature inside the vehicle at 25 degrees. For example, when the user selects the sleep mode, the user may use a heating device, a cooling device, or others. When the user selects the ‘others’ mode, the user may use a hair dryer or the like.

The remaining power, the amount of power consumption for V2L, and the power to move to the nearest charging station may be displayed on the GUI. For example, the remaining power of 80%, an amount of power consumption for V2L of 75%, and the power to move to the nearest charging station of 5% may be displayed on the GUI. The present disclosure provides a vehicle power guiding apparatus that may recommend the amount of power to be consumed by each V2L mode by taking into account the V2L selected by the user. For example, the vehicle power guiding apparatus may recommend the user to consume 20% of power in the rest mode, 40% in the camping mode, and 15% in the sleep mode. These recommendations may be displayed on the GUI.

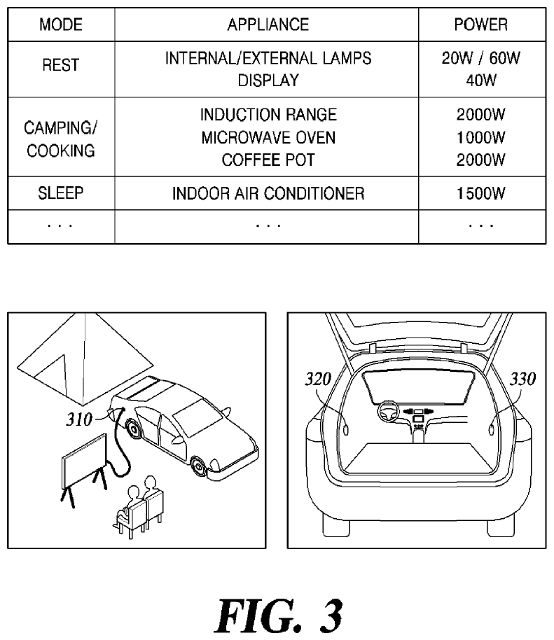

FIG. 3 is a diagram illustrating the purposes of V2L usage according to at least one embodiment of the present disclosure. The user may differentiate between V2L modes according to the purposes of V2L usage. The vehicle power guiding apparatus may determine appliances to be used in each V2L mode and display the estimated power consumption on the GUI. The vehicle power guiding apparatus may determine which appliances are being used by taking into account the amount of power consumed. The vehicle power guiding apparatus may cut off unnecessary V2L power. There may be charging devices that can be used for V2L inside and outside the vehicle.

As shown in FIG. 3, the user's usage of an internal/external lamp and a display product may be classified as the rest mode. 20 W and 60 W may be consumed for the use of internal and external lamps. 40 W may be consumed for use of a display product. The user's usage of an induction range, a microwave oven, a coffee pot, or the like may be classified as the camping mode or the cooking mode. Using the induction range may consume 2000 W. Using the microwave oven may consume 1000 W. Using the coffee pot may consume 2000 W. The user's usage of an indoor air conditioner may be classified as sleep mode. Using the indoor air conditioner may consume 1500 W.

Upon selecting the camping mode, the user may receive power from an external charging device 310 of the vehicle to use the microwave oven, induction range, coffee pot, or the like. Upon selecting the rest mode, the user may receive power from an internal charging device 320 of the vehicle to use the internal and external lamps and the display device. Upon selecting the sleep mode, the user may receive power from another internal charging device 330 of the vehicle to use the indoor air conditioner.

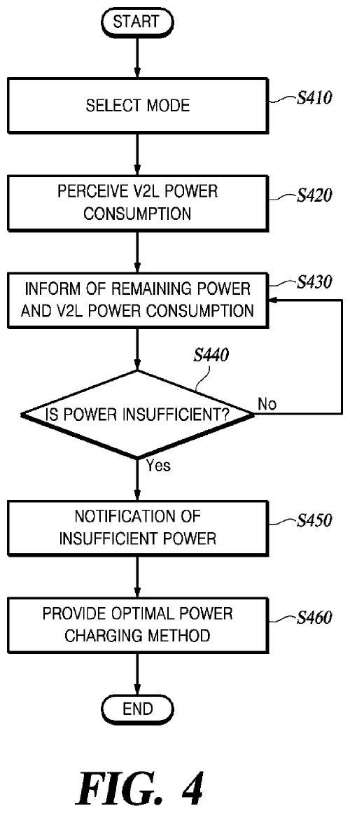

FIG. 4 is a flowchart of the process of informing of the electric power of a vehicle and providing a guide to power charging during parking or stopping, according to at least one embodiment of the present disclosure.

As shown in FIG. 4, the user may select a V2L mode (S410). The user may select sleep mode, rest mode, ‘others’ mode, camping mode, and the like. The vehicle power guiding apparatus may perceive the amount of power consumption for V2L (S420). The vehicle power guiding apparatus may perceive the amount of power consumption for V2L by taking into account the electronic products and the like being used. The vehicle power guiding apparatus may inform the user of the amount of remaining power and the amount of power consumption for V2L (S430). In addition to the amount of remaining power and the amount of power consumption for V2L, the vehicle power guiding apparatus may inform the user of the amount of power consumption to move to the nearest charging station. The vehicle power guiding apparatus may take into account the amount of remaining power, the V2L modes, and the like to inform the user of the recommended amounts of power for the V2L modes. These guidance contents may be displayed on the GUI.

The vehicle power guiding apparatus may determine whether or not the power is insufficient (S440). The vehicle power guiding apparatus may determine whether or not the power is insufficient by taking into account the remaining power and the amount of power consumption to move to the nearest charging station. When the remaining power is less than the amount of power consumption to move to the nearest charging station, the vehicle power guiding apparatus may determine that the power is insufficient. Upon determining that the power is not insufficient (S440—NO), the vehicle power guiding apparatus may inform the user of the amount of remaining power and the amount of power consumption for V2L (S430). Upon determining that the power is insufficient (S440—YES), the vehicle power guiding apparatus may inform the user that the power is insufficient (S450). This power shortage notification may be provided to the user through voice or display.

After the power shortage notification is provided to the user, the vehicle power guiding apparatus may provide an optimal power charging method to the user (S460). The vehicle power guiding apparatus may determine an optimal power charging method by considering occupants in the vehicle, remaining power, amount of power consumption to move to the nearest charging station, and the presence or absence of nearby V2L-capable vehicles. The optimal power charging method may be displayed on the GUI. The optimal power charging method may include moving to the nearest charging station, requesting an on-call charging vehicle, calling a vehicle that is V2L capable, cutting off power used for V2L, and the like.

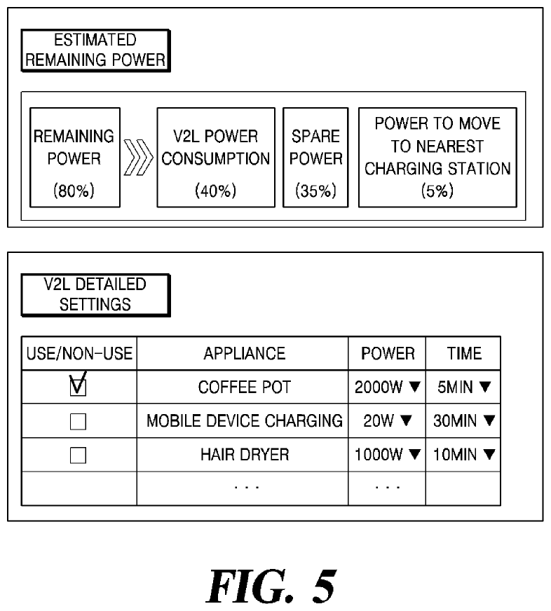

FIG. 5 is a diagram illustrating a GUI informing of the electric power of a vehicle while driving, according to at least one embodiment of the present disclosure. When the vehicle is driving, the user may use electronic products and the like. The amount of power consumption for V2L, the amount of remaining power, the amount of power consumption to move to the nearest charging station, and the amount of spare power may be displayed on the GUI. The vehicle power guiding apparatus may identify the electronic products in use and inform the user of the recommended use time of these electronic products.

As shown in FIG. 5, when the vehicle is driving, the user may use a coffee pot. The user may use less than 2000 W of power for the coffee pot within 5 minutes. For example, when charging a mobile device while the vehicle is driving, the user may use power less than 20 W for charging the mobile device within 30 minutes. For example, when using a hair dryer, the user may use less than 1000 W of power for the hair dryer within 10 minutes.

The remaining power, the amount of power consumption for V2L, the amount of spare power, and the amount of power consumption to move to the nearest charging station may be displayed on the GUI. The amount of spare power may be used for vehicle driving or additional V2L. For example, the remaining power of 80%, the amount of power consumption for V2L of 40%, the amount of spare power of 35%, and the amount of power consumption to move to the nearest charging station of 5% may be displayed on the GUI. The vehicle power guiding apparatus may take into account the electronic product used by the user and recommend an electronic product usage time. For example, when the user uses the coffee pot, the vehicle power guiding apparatus may recommend the user to use the coffee pot for 5 minutes. These recommendations may be displayed on the GUI.

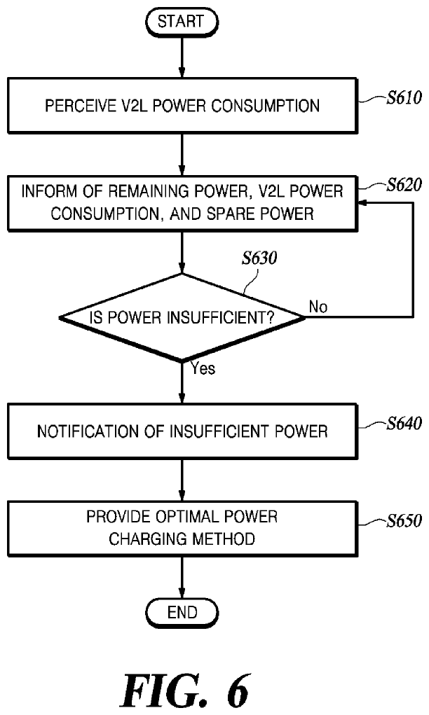

FIG. 6 is a flowchart of the process of informing of a vehicle's electric power and providing a guide to power charging while driving, according to at least one embodiment of the present disclosure.

As shown in FIG. 6, when the vehicle is driving, the user may use an electronic product or the like in the vehicle. The vehicle power guiding apparatus may perceive the amount of power consumption for V2L (S610). The vehicle power guiding apparatus may perceive the amount of power consumption for V2L by taking into account the electronic products being used and the like. The vehicle power guiding apparatus may inform the user of the amount of remaining power, the amount of spare power, and the amount of power consumption for V2L (S620). In addition to the amount of remaining power, the amount of spare power, and the amount of power consumption for V2L, the vehicle power guiding apparatus may inform the user of the amount of power consumption to move to the nearest charging station. The vehicle power guiding apparatus may inform the user of the recommended use time of each electronic product by taking into account the amount of remaining power and the electronic products in use. These guidance contents may be displayed on the GUI.

The vehicle power guiding apparatus may determine whether or not the power is insufficient (S630). The vehicle power guiding apparatus may determine whether or not the vehicle power is insufficient by taking into account the remaining power and the amount of power consumption to move to the nearest charging station. When the remaining power is less than the amount of power consumption to move to the nearest charging station, the vehicle power guiding apparatus may determine that the power is insufficient. Upon determining that the power is not insufficient (S630—NO), the vehicle power guiding apparatus may inform the user of the amount of remaining power, the amount of spare power, and the amount of power consumption for V2L (S620). Upon determining that the power is insufficient (S630—YES), the vehicle power guiding apparatus may notify the user that the power is insufficient (S640). This power shortage notification may be provided to the user through voice or display.

After the power shortage notification is provided to the user, the vehicle power guiding apparatus may provide the user with an optimal charging method (S650). The vehicle power guiding apparatus may determine an optimal charging method by taking into account the occupants in the vehicle, remaining power, the amount of power consumption to move to the nearest charging station, and the presence or absence of nearby V2L vehicles. The optimal charging method may be displayed on the GUI. The optimal charging method may include moving to the nearest charging station, requesting an on-call charging vehicle, calling a V2L-capable vehicle, and cutting off power used for V2L.

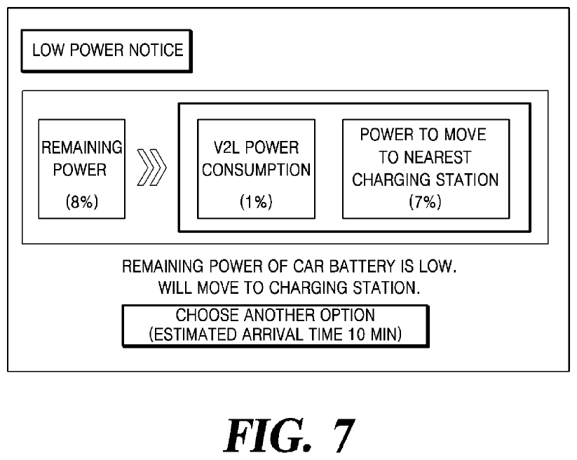

FIG. 7 is a diagram illustrating a GUI informing of the electric power of the vehicle when the vehicle power is low, according to at least one embodiment of the present disclosure. When the vehicle power is insufficient while the vehicle is parked or stopped or driving, the vehicle power guiding apparatus may inform the user of an optimal charging method. These guidance contents may be displayed on the GUI. Whether the power is insufficient may be determined by considering the remaining power and the amount of power consumption to move to the nearest charging station. The vehicle may move to a nearby charging station and return to the user after charging. If there is no charging station around the vehicle, the vehicle can consume the remaining power as V2L power and call a nearby V2L-capable vehicle or a specialized charging vehicle.

As shown in FIG. 7, when vehicle power is insufficient, residual power, amount of power consumption for V2L, and amount of power consumption to move to the nearest charging station may be displayed on the GUI. For example, the GUI may display the remaining power of 8%, the amount of power consumption for V2L of 1%, and the amount of power consumption to move to the nearest charging station of 7% may be displayed on the GUI. The vehicle power guiding apparatus may block the use of an electronic product in consideration of the electronic products in use by the user. The vehicle power guiding apparatus may limit the use of electronic products in consideration of the electronic products in use by the user. For example, when the user uses a coffee pot, the vehicle power guiding apparatus may block the use of the coffee pot. The vehicle power guiding apparatus may recommend an optimal charging method to the user. In this case, the user may select options other than the recommended charging method.

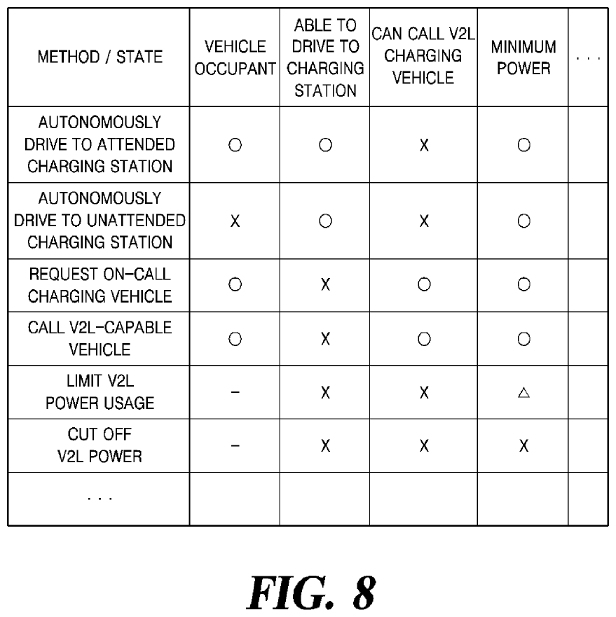

FIG. 8 is a diagram for explaining an optimal vehicle power charging method according to at least one embodiment of the present disclosure.

As shown in FIG. 8, upon determining that the vehicle power is insufficient, the vehicle power guiding apparatus may determine an optimal charging method. The optimal charging method may be moving to an attended charging station by autonomous driving, moving to an unattended charging station by autonomous driving, requesting an on-call charging vehicle, calling a V2L-capable vehicle, limiting the use of V2L power, and cutting off V2L power. The vehicle power guiding apparatus may determine an optimal charging method by taking into account the occupants in the vehicle, whether the vehicle can drive to a charging station, whether a V2L-capable vehicle can be called, and a minimum amount of power. Here, the minimum amount of power may mean the power consumption to move to the nearest charging station.

For example, where an occupant is present in the vehicle, the vehicle is able to drive to the charging station, a V2L-capable vehicle cannot be called, and there is a minimum amount of power, the vehicle power guiding apparatus may determine the autonomous driving to an attended charging station as the optimal power charging method.

For example, where no occupant is in the vehicle, the vehicle is able to drive to the charging station, a V2L-capable vehicle cannot be called, and there is a minimum amount of power, the vehicle power guiding apparatus may determine the autonomous driving to an unattended charging station as the optimal power charging method.

For example, when an occupant is present in the vehicle, the vehicle is not able to drive to the charging station, a V2L-capable vehicle can be called, and there is a minimum amount of power, the vehicle power guiding apparatus may determine the requesting of an on-call charging vehicle as the optimal power charging method.

For example, when an occupant is present in the vehicle, the vehicle is not able to drive to the charging station, a V2L-capable vehicle can be called, and there is the minimum amount of power, the vehicle power guiding apparatus may determine the calling of a V2L-capable vehicle as the optimal power charging method.

For example, when the vehicle is not able to drive to the charging station and a V2L-capable vehicle cannot be called, with the minimum amount of power being present or absent, the vehicle power guiding apparatus may determine the limiting of the use of V2L power as the optimal power charging method.

For example, when the vehicle is not able to drive to the charging station, a V2L-capable vehicle cannot be called, and there is no minimum amount of power, the vehicle power guiding apparatus may determine cutting off the V2L power as the optimal power charging method.

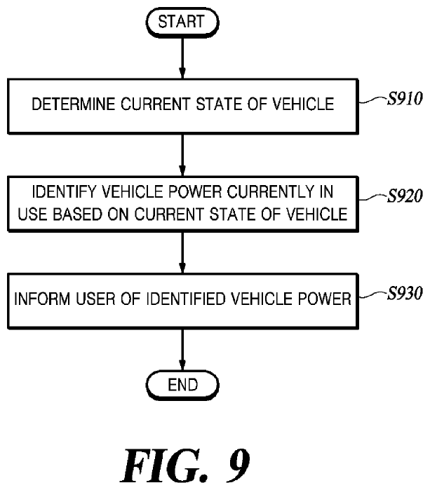

FIG. 9 is a flowchart of a method of providing information on the vehicle power according to at least one embodiment of the present disclosure.

As shown in FIG. 9, the vehicle power guiding apparatus may determine the current state of the vehicle (S910). The vehicle power guiding apparatus may identify the vehicle power currently used based on the current state of the vehicle (S920). The step of identifying the vehicle power currently used may include identifying, when the vehicle is in a parked state or a stopped state, at least one of an amount of power consumption for V2L, an amount of remaining power, or a minimum amount of power, wherein the amount of power consumption for V2L may be classified according to the mode selected by the user, and wherein the minimum amount of power may correspond to the amount of power consumption to move to the nearest charging station from the location of the vehicle. The step of identifying the vehicle power currently used may include identifying, when the vehicle is in a driving state, at least one of the amount of power consumption for V2L, the amount of remaining power, the amount of spare power, or the minimum amount of power, wherein the amount of power consumption for V2L may be classified according to the electronic product that the user utilizes.

The vehicle power guiding apparatus may inform the user of the identified vehicle power (S930). The step of informing the user of the identified vehicle power may include recommending the amount of power for each mode selected by the user when the vehicle is in a parked state or a stopped state. The step of informing the user of the identified vehicle power may include recommending the amount of power for each electronic product that the user utilizes when the vehicle is in a driving state. The current state of the vehicle includes at least one of the parked state, the stopped state, or the driving state, and the identified vehicle power may be displayed on the GUI.

The vehicle power guiding apparatus may determine whether the vehicle power is insufficient. Upon determining that the vehicle power is insufficient, the vehicle power guiding apparatus may inform the user that the vehicle power is insufficient. The vehicle power guiding apparatus may inform the user of an optimal charging method. The step of determining whether the vehicle power is insufficient may include determining whether the vehicle power is insufficient by comparing the amount of remaining power with the minimum amount of power. The step of informing the user of the optimal charging method may include informing the user of the optimal charging method based on at least one of the information items of occupants in the vehicle, charging stations around the vehicle, V2L-capable vehicles around the vehicle, or the minimum amount of power. The optimal charging method may include at least one of moving to an attended charging station, moving to an unattended charging station, requesting an on-call charging vehicle, calling a V2L-capable vehicle, cutting off V2L power consumption, or limiting V2L power consumption.

The apparatus or method according to the present disclosure may have the respective components arranged to be implemented as hardware or software, or a combination of hardware and software. Additionally, each component may be functionally implemented by software, and a microprocessor may execute the function by software for each component when implemented.

Various implementations of the systems, techniques, and the like described herein may be realized by digital electronic circuitry, integrated circuits, field-programmable gate arrays (FPGAs), application-specific integrated circuits (ASICs), computer hardware, firmware, software, and/or their combination. These various implementations can include those realized in one or more computer programs executable on a programmable system. The programmable system includes at least one programmable processor coupled to receive and transmit data and instructions from and to a storage system, at least one input device, and at least one output device, wherein the programmable processor may be a special-purpose processor or a general-purpose processor. Computer programs, which are also known as programs, software, software applications, or codes, contain instructions for a programmable processor and are stored in a “computer-readable recording medium.”

The computer-readable recording medium includes any type of recording device on which data that can be read by a computer system are recordable. Examples of computer-readable recording mediums include non-volatile or non-transitory media such as a ROM, CD-ROM, magnetic tape, floppy disk, memory card, hard disk, optical/magnetic disk, storage devices, and the like. The computer-readable recording medium further includes transitory media such as data transmission medium. Further, the computer-readable recording medium can be distributed in computer systems connected via a network, wherein the computer-readable codes can be stored and executed in a distributed mode.

Although the steps in the respective flowcharts/timing charts are described in this specification as being sequentially performed, they merely instantiate the technical idea of some embodiments of the present disclosure. Therefore, a person having ordinary skill in the pertinent art could perform the steps by changing the sequences described in the respective flowcharts/timing charts or by performing two or more of the steps in parallel, and hence the steps in the respective flowcharts/timing charts are not limited to the illustrated chronological sequences.

The present disclosure can provide a method and an apparatus for distinguishing between V2L modes according to the purpose of using the V2L feature.

Additionally, the present disclosure can provide a method and an apparatus for recommending a power usage plan to a user according to the purpose of using V2L and the amount of remaining power.

Further, the present disclosure can provide a method and an apparatus for providing a user with an optimal vehicle power charging method.

The effects of the present disclosure are not limited to those mentioned above, and other unmentioned effects will be clearly understood by those skilled in the art from the above description.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method comprising:
determining, by a vehicle power guiding apparatus, a current state of the vehicle;
identifying, by the vehicle power guiding apparatus, electric power of the vehicle currently in use based on the current state of the vehicle; and
informing, by the vehicle power guiding apparatus, a user of an identified electric power of the vehicle,
wherein the current state of the vehicle includes at least one of a parked state, a stopped state, or a driving state, and
wherein the identified electric power of the vehicle is displayed on a Graphical User Interface (GUI).

2. The method of claim 1, further comprising:
determining whether the electric power of the vehicle is insufficient;
informing the user that the electric power of the vehicle is insufficient upon determination that the electric power of the vehicle is insufficient; and
informing the user of an optimal charging method.

3. The method of claim 2, wherein determining whether the electric power of the vehicle is insufficient comprises comparing an amount of remaining power with a minimum amount of power to determine whether the electric power of the vehicle is insufficient.

4. The method of claim 2, wherein informing the user of the optimal charging method comprises informing the user of the optimal charging method based on at least one of an occupant in the vehicle, a charging station near the vehicle, a vehicle that is Vehicle-to-Load (V2L) capable near the vehicle, or a minimum amount of power.

5. The method of claim 2, wherein the optimal charging method comprises at least one of moving to an attended charging station, moving to an unattended charging station, requesting an on-call charging vehicle, calling a vehicle that is V2L capable, cutting off V2L power consumption, or limiting V2L power consumption.

6. The method of claim 1, wherein identifying the electric power comprises:
when the vehicle is in the parked state or the stopped state, identifying at least one of an amount of V2L power consumption, an amount of remaining power, or a minimum amount of power,
wherein an amount of power consumption for V2L is classified according to a mode selected by the user, and
wherein a minimum amount of power is an amount of power for the vehicle to move from a current location of the vehicle to a nearest charging station.

7. The method of claim 1, wherein identifying the electric power comprises:
when the vehicle is in the driving state, identifying at least one of an amount of power consumption for V2L, an amount of remaining power, an amount of spare power, or a minimum amount of power,
wherein the amount of power consumption for V2L is classified according to an electronic product in use by the user.

8. The method of claim 1, wherein informing the user of the identified electric power of the vehicle comprises:
when the vehicle is in the parked state or the stopped state, recommending an amount of power for each mode selected by the user.

9. The method of claim 1, wherein informing the user of the identified electric power of the vehicle comprises:
when the vehicle is in the driving state, recommending an amount of power for each electronic product utilized by the user.

10. A vehicle power guiding apparatus comprising:
a memory; and
a processor configured to:
determine a current state of a vehicle,
identify electric power of the vehicle currently in use based on the current state of the vehicle, and
inform a user of an identified electric power of the vehicle,
wherein the current state of the vehicle includes at least one of a parked state, a stopped state, or a driving state, and
wherein the identified electric power of the vehicle is displayed on a Graphical User Interface (GUI).

11. The vehicle power guiding apparatus of claim 10, wherein the processor is configured to:
determine whether the electric power of the vehicle is insufficient,
inform the user that the electric power of the vehicle is insufficient upon determination that the electric power of the vehicle is insufficient, and
inform the user of an optimal charging method.

12. The vehicle power guiding apparatus of claim 11, wherein the processor is configured to compare an amount of remaining power with a minimum amount of power to determine whether the electric power of the vehicle is insufficient.

13. The vehicle power guiding apparatus of claim 11, wherein the processor is configured to inform the user of the optimal charging method based on at least one of an occupant in the vehicle, a charging station near the vehicle, a vehicle that is V2L capable near the vehicle, or a minimum amount of power.

14. The vehicle power guiding apparatus of claim 11, wherein the optimal charging method comprises at least one of moving to an attended charging station, moving to an unattended charging station, requesting an on-call charging vehicle, calling a vehicle that is V2L capable, cutting off V2L power consumption, or limiting V2L power consumption.

15. The vehicle power guiding apparatus of claim 10,
wherein the processor is configured to identify at least one of an amount of V2L power consumption, an amount of remaining power, or a minimum amount of power when the vehicle is in the parked state or the stopped state,
wherein an amount of power consumption for V2L is classified according to a mode selected by the user, and
wherein the minimum amount of power is an amount of power for the vehicle to move from a current location of the vehicle to a nearest charging station.

16. The vehicle power guiding apparatus of claim 10,
wherein the processor is configured to identify at least one of an amount of power consumption for V2L, an amount of remaining power, an amount of spare power, or a minimum amount of power when the vehicle is in the driving state, and
wherein the amount of power consumption for V2L is classified according to an electronic product used by the user.

17. The vehicle power guiding apparatus of claim 10, wherein the processor is configured to recommend an amount of power for each mode selected by the user when the vehicle is in the parked state or the stopped state.

18. The vehicle power guiding apparatus of claim 10, wherein the processor is configured to recommend an amount of power for each electronic product used by the user when the vehicle is in the driving state.
